(19) United States
(12) Patent Application Publication
(10) Pub. No.: US 2020/0131085 A1
(43) Pub. Date: Apr. 30, 2020

(54) METHODS AND SYSTEMS FOR CHEMICALLY STRENGTHENING LITHIUM-CONTAINING GLASS

(71) Applicant: CORNING INCORPORATED, Corning, NY (US)

(72) Inventors: Hongmei Hu, Painted Post, NY (US); Yuhui Jin, Painted Post, NY (US); Qiao Li, Horseheads, NY (US)

(21) Appl. No.: 16/668,181

(22) Filed: Oct. 30, 2019

Related U.S. Application Data
(60) Provisional application No. 62/753,459, filed on Oct. 31, 2018.

(51) Int. Cl. C03C 21/00

(52) U.S. Cl. CPC C03C 21/002

(57) ABSTRACT

Methods and systems of strengthening lithium-containing glass-based substrates including contacting at least a portion of the lithium-containing glass-based substrates with a first salt bath comprising at least 2 wt. % lithium nitrate and at least one of potassium nitrate and sodium nitrate and contacting at least a portion of the lithium-containing glass-based substrates with a second salt bath comprising at least one of potassium nitrate and sodium nitrate. The methods further include that after contacting 3 m² of glass per kilogram of molten salt (3 m²/kg salt) to 13 m²/kg salt for the first salt bath, a surface compressive stress imparted to the glass articles by the contacting steps decreases by less than 30 MPa.

### CROSS-REFERENCE TO RELATED APPLICATIONS

This application claims the benefit of priority of U.S. Provisional Application Ser. No. 62/753,459 filed on Oct. 31, 2018, the content of which is relied upon and incorporated herein by reference in its entirety.

### TECHNICAL FIELD

The present disclosure generally relates to methods for chemically strengthening lithium-containing glass. More particularly, the disclosure relates to methods for using lithium-containing baths for strengthening glass and glass-ceramic substrates and maintaining a lithium concentration throughout ion exchange processes to prevent or reducing the formation of surface defects.

### BACKGROUND

Tempered or strengthened glass is often used in consumer electronic devices, such as smart phones and tablets, because of its physical and chemical durability and toughness as compared to non-strengthened glass. For example, strengthened glass is known to have improved scratch resistance and drop performance compared to non-strengthened glass. Both scratch performance and drop performance are believed to be dictated, at least partially, by surface compressive stress (CS), depth of compression (DOC), knee stress or the stress value at the transition point of two stress slopes (CSk), and central tension (CT).

In general, the durability of tempered glass and glass-ceramic articles increases with increasing CS and DOC of the glass or glass-ceramic article. To provide a larger CS and deepen the DOC, ion exchange processes may be used as the strengthening process for glass or glass-ceramic substrates.

In ion exchange processes, a glass or glass-ceramic substrate containing at least one alkali metal cation is immersed in a salt bath containing at least one larger alkali metal cation. The smaller alkali metal cations diffuse from the glass surface into the salt bath while larger alkali metal cations from the salt bath replace these smaller cations in the surface of the glass. This substitution of larger cations for smaller cations in the glass creates a compressive stress layer at the glass surface, thus increasing the glass's resistance to breakage. As the ion exchange proceeds, the salt bath concentration of the smaller alkali metal cations (i.e., the cations that diffuse from the glass into the salt bath) increases while the salt bath concentration of the larger alkali metal cations (i.e., the cations that migrate into the glass from the salt bath) decreases.

The diffusion of the smaller alkali metal cations from the glass or glass-ceramic substrate into the salt bath “poisons” the salt bath. Eventually the salt bath reaches a threshold limit of smaller alkali metal cation poisoning, and when this occurs, the salt bath may require restoration. Restoration may include cooling the salt, emptying the salt bath, refilling the bath with fresh salt, or melting the fresh salt. Alternatively, phosphate salts can be added to the salt bath to precipitate out the poisoning cations. Such restoration methods result in process down time, decreased production efficiencies, and increased manufacturing costs.

Additionally, additive salts present in the bath for lithium ion removal, such as phosphate salts, may crystallize on the surface of the article upon removal from the salt bath following the ion exchange process. Once the article has cooled, it may be difficult to remove the crystals from the surface, which can generate surface defects in the article—including depressions and protrusions. Dimpled, stippled glass is often not commercially desired and may not be usable in most industries, potentially rendering the article unsuitable for its intended purpose.

Accordingly, a need exists for alternative methods for strengthening glass or glass-ceramic substrates by ion exchange.

### SUMMARY

Embodiments herein address these needs by providing methods of using lithium-containing baths to maintain a lithium concentration throughout an ion exchange processes for strengthening glass and glass-ceramic substrates while preventing or reducing the formation of surface defects.

In an embodiment, a method of strengthening lithium-containing substrates includes contacting at least a portion of the lithium-containing substrate with a first salt bath comprising at least 2 wt. % lithium nitrate and at least one of potassium nitrate and sodium nitrate and subsequently contacting at least a portion of the lithium-containing substrate with a second salt bath comprising at least one of potassium nitrate and sodium nitrate. The lithium cations diffuse from the lithium-containing substrate and dissolve in the first salt bath. Also, the lithium cations diffuse from the lithium-containing substrate and dissolve in the second salt bath.

In another embodiment, a method for ion exchange strengthening lithium-containing glass substrates comprising lithium cations includes contacting a first batch of glass substrates with a first salt bath comprising greater than 2 wt. % lithium nitrate and at least one of potassium nitrate and sodium nitrate and then contacting the first batch of the glass articles with a second salt bath comprising at least one of potassium nitrate and sodium nitrate. The lithium cations diffuse from the lithium-containing glass substrate and dissolve in the first salt bath. Additionally, the lithium cations diffuse from the lithium-containing glass substrate and dissolve in the second salt bath. After treating glass with a cumulative surface area of 3 m² per kilogram of molten salt (3 m²/kg salt) to 13 m²/kg salt with the first salt bath, a surface compressive stress imparted to the glass articles by the contacting steps decreases by less than 30 MPa.

### BRIEF DESCRIPTION OF THE DRAWINGS

FIG. 1A schematically depicts a salt bath during a known ion exchange process before lithium poisoning;

FIG. 1B schematically depicts a salt bath during a known ion exchange process after lithium poisoning;

FIG. 2A schematically depicts a salt bath of a comparative known method at the time of adding a phosphate salt to a lithium-poisoned salt bath;

FIG. 2B schematically depicts a salt bath of a comparative known method after adding a phosphate salt to a lithium-poisoned salt bath, which forms an insoluble phosphate precipitate;

FIG. 3A schematically depicts a first salt bath of the disclosed method before lithium poisoning by a lithium-containing substrate;

FIG. 3B schematically depicts a first salt bath of the disclosed method after lithium poisoning by a lithium-containing substrate;

FIG. 4A schematically depicts a second salt bath of the disclosed method before lithium poisoning by a lithium-containing substrate;

FIG. 4B schematically depicts a second salt bath of the disclosed method after lithium poisoning by a lithium-containing substrate;

FIG. 5 graphically depicts the bath chemistry evolution as a function of the cumulative square meter (m²) of glass processed per 1 kilogram (kg) of molten salt for a single ion exchange model (the square meter (m²) of glass is defined by one side of the surface area of a flat glass);

FIG. 6 graphically depicts the change in CS as a function of the cumulative m² of glass processed per 1 kg of molten salt for a single ion exchange model;

FIG. 7 graphically depicts the bath chemistry evolution as a function of the cumulative m² of glass processed per 1 kg of molten salt for a double ion exchange model;

FIG. 8 graphically depicts the change in CS as a function of the cumulative m² of glass processed per 1 kg of molten salt for a double ion exchange model;

FIG. 9 graphically depicts the effect of lithium nitrate concentration level in a first salt bath on CS degradation;

FIG. 10 graphically depicts a comparison of the percentage weight gain after the first ion exchange and second ion exchange for salt baths with 0% LiNO₃ in the first salt bath, 2.2% LiNO₃ in the first salt bath, and 4.5% LiNO₃ in the first salt bath;

FIG. 11 graphically depicts the concentration profiles of lithium, sodium, and potassium (presented using their corresponding oxides mole concentration) after the first ion exchange for salt baths with 0% LiNO₃ in the first salt bath (Example 1), 2.2% LiNO₃ in the first salt bath (Example 2), and 4.5% LiNO₃ in the first salt bath (Example 3);

FIG. 12 graphically depicts the concentration profiles of lithium, sodium, and potassium (presented using their corresponding oxides mole concentration) after the second ion exchange for salt baths with 0% LiNO₃ in the first salt bath (Example 1), 2.2% LiNO₃ in the first salt bath (Example 2), and 4.5% LiNO₃ in the first salt bath (Example 3);

FIG. 13 graphically depicts the effect of lithium nitrate concentration level in a first salt bath on CS, CSk, and CT; and

FIG. 14 graphically depicts the effect of lithium nitrate concentration level in a first salt bath on drop performance on 180 grit sand paper.

### DETAILED DESCRIPTION

Embodiments described herein are directed to methods for maintaining the lithium concentration of salt baths used in ion exchange processes to extend salt bath life and maintain consistent properties of strengthened glass-based articles produced by the methods over time. Some embodiments include contacting at least a portion of a lithium-containing glass-based substrate with a first salt bath comprising at least 2 wt. % lithium nitrate (LiNO₃) and at least one of potassium nitrate (KNO₃) and sodium nitrate (NaNO₃), to form an ion-exchanged glass-based substrate. At least a portion of the ion-exchanged glass-based substrate is then contacted with a second salt bath comprising at least one of KNOB and NaNO₃ to form a glass-based article. In each bath, lithium cations diffuse from the glass-based substrate into the salt bath.

The following description of the embodiments is illustrative in nature and is in no way intended to be limiting in its application or use. Furthermore, it should be understood that like reference numbers indicate corresponding or related parts in the various figures.

As used herein, the terms “ion exchange bath,” “salt bath,” and “molten salt bath,” are, unless otherwise specified, equivalent terms, and refer to the solution or medium used to effect the ion exchange process with a glass-based substrate, in which cations within the surface of the glass-based substrate are replaced or exchanged with cations that are present in the salt bath. It is understood that in some embodiments the salt bath comprises at least one of KNO₃ and NaNO₃, and that the salt bath may be heated or otherwise treated to a form a substantially liquid salt bath.

As used herein, the term “glass-based” refers to any material made partly or wholly of glass, including glass materials, laminated materials including glass and crystalline materials, laminated materials including glass and non-crystalline materials, and glass-ceramic materials (including an amorphous glass phase and a ceramic phase). As utilized herein, the term “glass-based substrate” generally refers to glass-based materials prior to being subjected to ion exchange treatments. As utilized herein, the term “ion-exchanged glass-based substrate” generally refers to glass-based substrates after being subjected to an ion exchanged process, but prior to being subjected to the totality of ion exchange treatments employed to form glass-based articles. As utilized herein, the term “glass-based article” are formed by exposing glass-based substrates to a desired ion exchange treatment. By way of illustration, a glass-based article may be formed by subjecting a glass-based substrate to a two-step ion exchange process, with an ion-exchanged glass-based substrate existing between the first and second ion exchange steps. The glass-based substrates, ion-exchanged glass-based substrates, and glass-based articles may have any shape or form including, but not limited to, sheets, vials, and other three dimensional forms.

As used herein, the terms “cation” and “ion” are considered equivalent terms, unless otherwise specified. The terms “cation” and “ion” can also refer to one or more cations. While potassium and sodium cations and salts are used in embodiments, it is understood that all embodiments of the disclosure are not limited to these species. The scope of the present disclosure also includes other metal salts and ions, particularly cations and salts of the alkali metals, as well as those of other monovalent metals.

As used herein, the terms “selectively” and “selective” are used to refer to the affinity for a product or reaction mechanism to be promoted, such that the particular product or reaction mechanism occurs over other potential products or reactions.

As used herein, the term “diffusivity” refers to the molar flux of a species due to molecular diffusion or the concentration gradient of the particular species.

As used herein, the singular forms “a,” “an,” and “the” include plural referents unless the context clearly dictates otherwise. Thus, for example, reference to “a” component includes aspects having two or more such components, unless the context clearly indicates otherwise.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass-based article that is “substantially free of MgO” is one in which MgO is not actively added or batched into a composition, but may be present in very small amounts as a contaminant. Additionally, when a value is disclosed herein modified by the term “about,” the exact value is also disclosed. For example, “about 5 mol %” also discloses the exact value “5 mol %.”

Compressive stress is determined with a fundamental stress meter (FSM) instrument, such as the FSM-6000, manufactured by Orihara Co., Ltd. (Tokyo, Japan), with the compressive stress value based on the measured stress optical coefficient (SOC). The FSM instrument couples light into and out of the birefringent glass surface. The measured birefringence is then related to stress through a material constant, the stress-optic or photoelastic coefficient (SOC or PEC) and two parameters are obtained: the maximum surface compressive stress (CS) and the exchanged depth of layer (DOL).

A glass-based substrate containing at least one alkali metal cation may be strengthened through ion exchange processes that utilize molten salt baths. In a conventional single ion exchange process, a glass-based substrate is immersed, or at least partially immersed, in a salt bath containing at least one alkali metal cation that is larger than the alkali metal cation contained in the glass-based substrate. The smaller alkali metal cations diffuse from the glass-based substrate's surface into the salt bath while larger alkali metal cations from the salt bath replace these smaller cations in the surface of the glass-based substrate to form a glass-based article. This substitution of larger cations for smaller cations in the glass-based substrate creates a compressive stress layer at the glass-based article's surface, thus increasing the resistance of the glass-based article to breakage. As the ion exchange proceeds, the salt bath concentration of the smaller alkali metal cations (i.e., the cations that diffuse from the glass-based substrate into the salt bath) increases while the salt bath concentration of the larger alkali metal cations (i.e., the cations that migrate into the glass-based substrate from the salt bath) decreases.

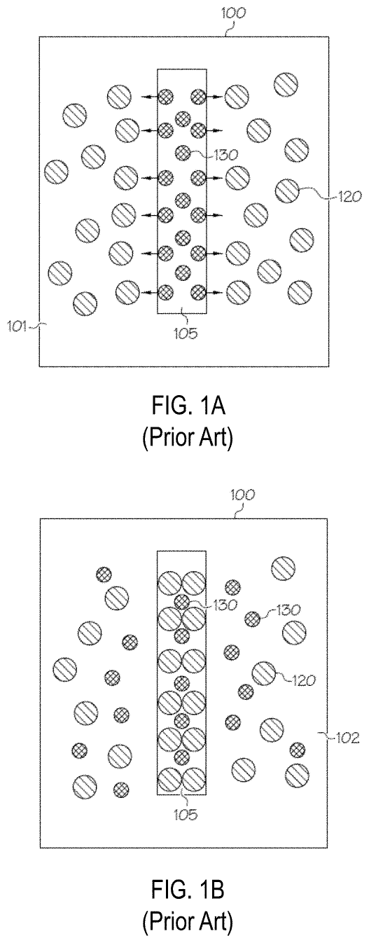

FIGS. 1A and 1B schematically depict a salt bath during a conventional single ion exchange process. The ion exchange process shown in FIGS. 1A and 1B includes immersing a glass-based substrate 105 containing lithium cations (smaller cations) 130 (also referred to as a “lithium-containing glass-based substrate”) in a salt bath 100, which contains fresh molten salt 101 containing larger alkali metal cations 120, where the larger alkali metal cations are larger than the lithium cations. The larger alkali metal cations 120 may comprise potassium, sodium, or combinations thereof, which have disassociated from KNOB, NaNO₃ or combinations thereof present in the salt bath 100. KNO₃—when compared to NaNO₃—comprises a larger alkali metal cation (i.e., K⁺ compared to Na⁺) that will more readily exchange with larger alkali metal cations in the glass-based substrate, such as Na⁺. Likewise, NaNO₃—when compared to KNO₃—comprises a smaller alkali metal cation (i.e., Na⁺ compared to K⁺) that more readily exchanges with smaller alkali metal cations in the glass-based substrate, such as lithium cations (Li⁺). Referring specifically to FIG. 1B, salt bath 100 is considered to be “poisoned,” when lithium cations 130 exchanged from the glass-based substrate are present in molten salt 102. Over time, the concentration of lithium cations 130 in the salt bath 100 increases as lithium cations 130 diffuse from the lithium-containing glass-based substrate 105 into the molten salt 102, and consequently, the poisoning level of the salt bath 100 increases.

The rate at which the salt bath 100 is poisoned during the conventional single ion exchange process may be reduced through a process known as “drag out.” Drag out occurs when lithium cations 130 that diffuse from the lithium-containing glass-based substrate 105 into the molten salt 102 stick to the outer surface of the strengthened lithium-containing glass-based substrate 105, which is then removed from the salt bath 100. However, drag out does not prevent lithium poisoning; it merely slows the rate of poisoning.

That is, if the amount of lithium cations diffusing from the lithium-containing glass-based substrate 105 into the molten salt 102 is greater than the lithium cations being removed from the salt bath 100 through drag out, the lithium cations of the system are “unbalanced.” If the concentration of lithium cations 130 entering and leaving the salt bath 100 remain unbalanced, the poisoning level of the salt bath 100 will continually increase over the life of the salt bath 100. The continually increasing poisoning level causes the ion exchange characteristics of the bath to degrade, which consequently causes the strength characteristics (including CS and DOC) of the lithium-containing glass-based articles to degrade. This problem creates inconsistent product attributes over a manufacturing run.

The degradation of the salt bath due to increased lithium poisoning may necessitate additional bath maintenance steps to maintain the amount lithium poisoning below a specified concentration level. In conventional ion exchange methods, this threshold level is generally understood to be 0.5 wt. % LiNO₃ or less, based on the total concentration of the molten salt. Such additional bath maintenance steps utilized to reduce the poisoning level below the threshold include frequently changing the molten salt bath and/or introducing “fresh” salt to counteract the poisoning. However, each of these processing steps increase processing costs and decrease processing throughput.

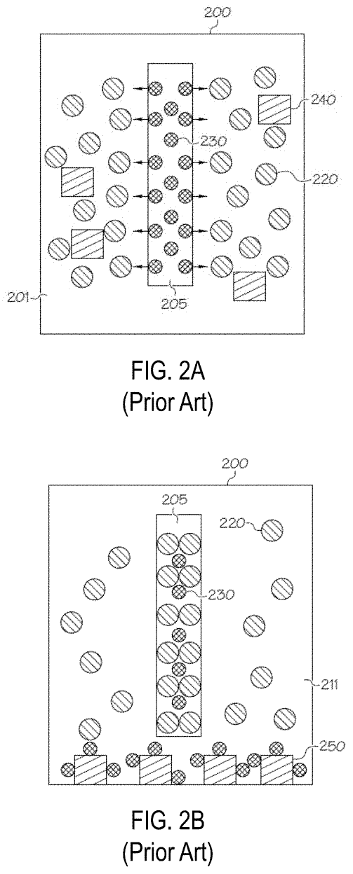

Alternatively, other conventional ion exchange processes may utilize phosphate salts that selectively precipitate the lithium cations from the salt bath, thereby reducing the poisoning level and maintaining the strength characteristics of the substrates. Referring now to a comparative process shown in FIG. 2A, a salt bath 200 with poisoned molten salt 201 contains lithium cations 230 in addition to larger alkali metal cations 220. In FIG. 2A, a phosphate salt 240 is added to the salt bath 200 to regenerate the poisoned molten salt 201. The phosphate salt 240 may comprise Na₃PO₄, K₃PO₄, Na₂HPO₄, K₂HPO₄, Na₅P₃O₁₀, K₅P₃₀₁₀, Na₂H₂P₂O₇, Na₄P₂O₇, K₄P₂O₇ Na₃P₃O₉, K₃P₃O₉, or combinations thereof. The phosphate salt 240 comprises cation and anions that dissolve in the salt bath and disassociate to form PO₄⁻³ anions and cations (including, but not limited to, sodium or potassium ions). The dissolved PO₄⁻³ anions present in the salt bath 200 react with and selectively precipitate the dissolved lithium cations 230, favoring a reaction with the lithium cations 230 over other potential reactions, such as a reaction with sodium cations or potassium cations in the salt bath 200. The selective precipitation reaction produces insoluble lithium phosphate (Li₃PO₄) in the salt bath 200.

The precipitation of insoluble lithium phosphate 250 reduces the poising level of the salt bath 211. In addition, the dissociation of alkali metal cations (such as sodium or potassium) from the phosphate salt 240 in favor of the formation of insoluble lithium phosphate 250 provides the salt bath 200 with more dissolved larger alkali metal cations 220 that can later be exchanged into the lithium-containing glass-based substrate 205. However, the insoluble lithium phosphate 250 formed from the selective precipitation reaction must then be removed from the salt bath 200. For example, the insoluble lithium phosphate 250 may settle to the bottom of the salt bath 200, which must be cleared or removed with a filter, sieve, strainer, or by other means. Alternatively, the insoluble lithium phosphate 250 may remain in the bottom of the salt bath 200.

Insoluble lithium phosphate 250 that remains in the bottom of salt bath 200 creates costly problems downstream in the manufacturing process. For example, the insoluble lithium phosphate 250 may stick to the surface of the lithium-containing glass-based articles, thereby creating stains, which makes the strengthened glass-based articles harder to clean in subsequent processing steps. Additionally, the accumulation of the insoluble lithium phosphate 250 in the bottom of the salt bath 200 eventually hampers the conventional ion exchange process. As a result, the insoluble lithium phosphate precipitate must be cleaned from the ion exchange salt bath, which can be time consuming and costly.

As such, embodiments of the disclosed method are directed to an ion exchange process for chemically strengthening lithium-containing glass-based substrates utilizing a process window that achieves relatively steady-state bath chemistry (salt composition), which results in extended bath life. Furthermore, embodiments of the disclosed methods achieve this relatively steady-state bath chemistry without bath maintenance steps—such as frequently changing the molten bath salt—and/or without generating solid precipitates in the salt bath—such as in the form of an insoluble phosphate. In addition to an extended bath life, the disclosed methods also provide for improved run-to-run “dimensional stability” in the dimensions of the strengthened glass-based articles as well as run-to-run consistency in CS, CSk, CT, DOC, and drop performance properties (“strength properties”) comparable to articles strengthened through conventional processes. “Dimensional stability” refers to the dimensional variation induced by the ion exchange process, which is a result of smaller monovalent metal ions in a substrate being replaced with monovalent ions of larger ionic radius. The percentage of smaller ions in the substrate and the radius of the larger ions in conjunction with the extent of the ion exchange determine the degree of dimensional expansion. As stated previously, the disclosed methods provide relatively steady-state bath chemistry, which influences the percentage of the ion replacement (exchange) in the glass thereby lessening the degree of expansion in the strengthened glass-based articles and allowing for improved run-to-run (or “batch-to-batch”) dimensional stability. Therefore, the disclosed methods provide an economically-efficient means for the production of strengthened glass-based articles without sacrificing product quality due to dimensional variations.

Embodiments described herein include contacting at least a portion of a lithium-containing glass-based substrate with a first salt bath comprising at least 2 wt. % lithium nitrate (LiNO₃) and at least one of potassium nitrate (KNO₃) and sodium nitrate (NaNO₃). In embodiments, the method may further include contacting at least a portion of the ion-exchanged lithium-containing glass-based substrate comprising lithium cations with a second salt bath comprising at least one of KNO₃ and NaNO₃. In each bath, lithium cations diffuse from the lithium-containing glass-based substrate into the salt bath.

In embodiments, the lithium-containing glass-based substrate is a glass or glass-ceramic substrate. The glass-based substrate may, in some embodiments, comprise alkali aluminosilicate or alkali aluminoborosilicate glass. The lithium-containing glass-based substrate may be formed from a glass composition which includes lithium, such as Li₂O. In some embodiments, the lithium-containing glass-based substrate may comprise from about 2.0 mol % Li₂O to about 25 mol % Li₂O, such as from about 2.0 mol % Li₂O to about 15 mol % Li₂O, from about 2.0 mol % Li₂O to about 10 mol % Li₂O, from about 2.5 mol % Li₂O to about 10 mol % Li₂O, from about 5.0 mol % Li₂O to about 15 mol % Li₂O, from about 5.0 mol % Li₂O to about 10 mol % Li₂O, or from about 5.0 mol % Li₂O to about 8 mol % Li₂O, and any and all sub-ranges formed from any of these end-points.

The amount of lithium present in the lithium-containing glass-based substrate may, in accordance with some embodiments, allow for the ion exchange process to occur at a faster rate when compared to the ion exchange processes of other glass-based substrates that do not contain lithium or that contain a lower amount of lithium. In some embodiments, a high lithium cation diffusion rate may be desired to decrease the time required for the ion exchange process. However, in some embodiments, a low lithium cation diffusion rate may be desired to reduce or prevent the formation of surface defects on the lithium-containing glass-based substrate. Without being bound to any particular theory, it is believed that lithium may more readily diffuse from the glass-based substrate into molten salt compared to other alkali metal cations.

In some embodiments, the lithium-containing glass-based substrate may include: greater than or equal to 50 mol % to less than or equal to 80 mol % SiO₂, greater than or equal to 0 mol % to less than or equal to 5 mol % B₂O₃, greater than or equal to 5 mol % to less than or equal to 30 mol % Al₂O₃, greater than or equal to 2 mol % to less than or equal to 25 mol % Li₂O, greater than or equal to 0 mol % to less than or equal to 15 mol % Na₂O, greater than or equal to 0 mol % to less than or equal to 5 mol % MgO, greater than or equal to 0 mol % to less than or equal to 5 mol % ZnO, greater than or equal to 0 mol % to less than or equal to 5 mol % SnO₂, and greater than or equal to 0 mol % to less than or equal to 10 mol % P₂O₅. In embodiments, the lithium-containing glass-based substrate may include: greater than or equal to 60 mol % to less than or equal to 75 mol % SiO₂, greater than or equal to 0 mol % to less than or equal to 3 mol % B₂O₃, greater than or equal to 10 mol % to less than or equal to 25 mol % Al₂O₃, greater than or equal to 2 mol % to less than or equal to 15 mol % Li₂O, greater than or equal to 0 mol % to less than or equal to 12 mol % Na₂O, greater than or equal to 0 mol % to less than or equal to 5 mol % MgO, greater than or equal to 0 mol % to less than or equal to 5 mol % ZnO, greater than or equal to 0 mol % to less than or equal to 1 mol % SnO₂, and greater than or equal to 0 mol % to less than or equal to 5 mol % P₂O₅. Any of the above-described compositional ranges may be combined with any other compositional range described herein, or modified by combination with any other end-point of a corresponding compositional range. It should be understood that, in some embodiments, the lithium-containing glass-based substrate may free or substantially free of one or more of B₂O₃, P₂O₅, MgO, ZnO, and SnO₂.

It should be understood that such glass glass-based compositions are example embodiments of lithium-containing glass-based substrate compositions that may be used in embodiments of the presently-disclosed method, and other lithium-containing glass-based substrate compositions are contemplated and possible.

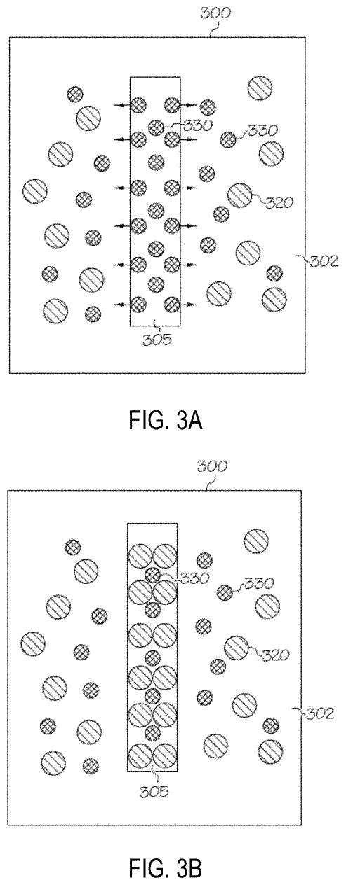

Referring now to FIGS. 3A and 3B, in some embodiments, at least a portion of the lithium-containing glass-based substrate 305 is contacted with a first salt bath 300. In embodiments of the disclosed method, one purpose of contacting at least a portion of a lithium-containing glass-based substrate 305 with a first salt bath 300 is to establish a deep DOC for the final stress profile of the substrate. The lithium-containing glass-based substrate 305 may be brought into contact with the molten salt through immersion in the first salt bath 300 or other similar means. In other embodiments, the lithium-containing glass-based substrate 305 may be fully submerged in the first salt bath 300. The lithium-containing glass-based substrate 305 may be brought into contact with the first salt bath 300 multiple times, including but not limited to, dipping the lithium-containing glass-based substrate 305 into the first salt bath 300 multiple times.

The ion exchange process shown in FIGS. 3A and 3B includes immersing a glass-based substrate 305 containing lithium cations (smaller cations) 330 in a salt bath 300, which contains poisoned molten salt 302 containing larger alkali metal cations 320 lithium cations 330, where the larger alkali metal cations 320 are larger than the lithium cations 330. The larger alkali metal cations 320 may comprise potassium, sodium, or combinations thereof, which have disassociated from KNOB, NaNO₃ or combinations thereof present in the salt bath 300. Referring specifically to FIG. 3B, lithium cations 330 have diffused from the lithium-containing glass-based substrate 305 into the poisoned molten salt 302.

In some embodiments, the lithium-containing glass-based substrate 305 may be contacted with the first salt bath 300 for a first treatment time. In embodiments, the first treatment time may be from about 20 minutes to about 20 hours, such as from about 20 minutes to about 15 hours, from about 20 minutes to about 10 hours, from about 20 minutes to about 5 hours, from about 20 minutes to about 1 hour, from about 1 hour to about 20 hours, from about 1 hour to about 15 hours, from about 1 hour to about 10 hours, from about 1 hour to about 5 hours, from about 5 hours to about 20 hours, from about 5 hours to about 15 hours, from about 5 hours to about 10 hours, from about 10 hours to about 20 hours, from about 10 hours to about 15 hours, or from about 15 hours to about 20 hours, and any and all sub-ranges formed from these endpoints.

In embodiments described herein, the first salt bath 300 may comprise at least 2 wt. % lithium nitrate (LiNO₃). In some of these embodiments, the first salt bath 300 may comprise up to 40 wt. % LiNO₃. In embodiments, the initial concentration of LiNO₃ in the first salt bath may be greater than 2 wt. %, depending on the composition of the lithium-containing glass-based substrate 305, to provide an ion exchange process that has a greater capacity to extend the life of the first salt bath. By increasing the LiNO₃ concentration limit in the first salt bath, such as to at least 2 wt. % LiNO₃, the bath operates at a near steady-state concentration of lithium ions because there is balance between the lithium cations diffusing from the lithium-containing substrate into the first salt bath and the lithium cations removed from the first salt bath through drag out. Therefore, the disclosed methods allow for consistent strength characteristics for the glass-based articles strengthened therein and also extends the bath life for the first salt bath, when compared to conventional methods, which operate at lesser poisoning levels, such as below 0.5 wt. % LiNO₃. In embodiments, the first salt bath 300 may initially comprise from about 2 wt. % to about 40 wt. % LiNO₃, such as from about 2 wt. % to about 6 wt. % LiNO₃, about 2.5 wt. % to about 6 wt. % LiNO₃, or from about 2 wt. % to about 5 wt. % LiNO₃, and any and all sub-ranges formed from these endpoints.

In the embodiments described herein, the first salt bath 300 may further comprise at least one of KNO₃ and NaNO₃. In some embodiments, the first salt bath 300 may comprise a combination of KNO₃ and NaNO₃. In embodiments, the concentrations of KNO₃ and NaNO₃ in the first salt bath may be balanced based on the composition of the lithium-containing glass-based substrate 305 to provide an ion exchange process that increases both CS and DOL. In further embodiments, the first salt bath comprises a greater concentration of potassium nitrate (KNO₃) than sodium nitrate (NaNO₃) based on the total concentration of the first salt bath. In embodiments, the first salt bath 300 may comprise from about 5 wt. % to about 95 wt. % KNO₃, such as from about 45 wt. % to about 50 wt. % KNO₃, or from about 75 wt. % to about 95 wt. % KNO₃, and any and all sub-ranges formed from these endpoints. In embodiments, the first salt bath 300 may comprise from about 5 wt. % to about 95 wt. % NaNO₃, such as from about 50 wt. % to about 55 wt. % NaNO₃, or from about 5 wt. % to about 25 wt. % NaNO₃, and any and all sub-ranges formed from these endpoints. To establish a deep DOC for the final stress profile of the glass-based article, the first salt bath 300 may be operated with a greater concentration of NaNO₃ and for a longer treatment time, as compared to the second salt bath 400 (if utilized), which will be discussed further herein.

In some embodiments, the first salt bath 300 may be free or substantially free of phosphate salts, such as trisodium phosphate. In embodiments, the first salt bath 300 may contain from 0 wt. % to about 1 wt. % trisodium phosphate, such as from 0 wt. % to about 0.5 wt. % trisodium phosphate, or from 0 wt. % to about 0.1 wt. % trisodium phosphate, and any and all sub-ranges formed from these endpoints.

As stated previously, the ion exchange process is promoted by heating the first salt bath 300 during the exchange. However, if the temperature of the first salt bath 300 is too high, it may be difficult to adequately control the ion exchange process, the DOC can increase too quickly without obtaining the desired CS due to stress relaxation at an elevated temperature, and hazardous nitrogen oxide gas may be generated. Accordingly, the first salt bath 300 may, in some embodiments, be heated to a temperature from about 350° C. to about 550° C., such as from about 350° C. to about 500° C., from about 350° C. to about 450° C., from about 350° C. to about 400° C., from about 450° C. to about 550° C., from about 450° C. to about 500° C., or from about 500° C. to about 550° C., and any and all sub-ranges formed from these endpoints.

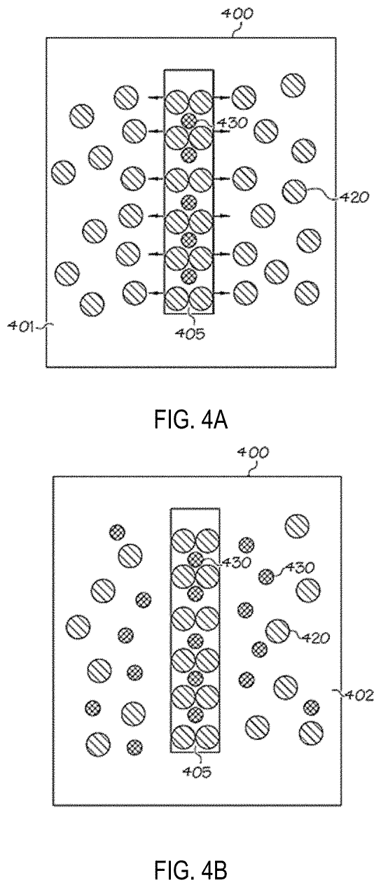

Referring now to FIGS. 4A and 4B, in some embodiments, at least a portion of the lithium-containing ion-exchanged glass-based substrate 405 (which corresponds to the lithium-containing glass-based substrate 305 in FIGS. 3A and 3B after being contacted with the first salt bath) is contacted with a second salt bath 400. One purpose of contacting at least a portion of a lithium-containing ion-exchanged glass-based substrate 405 with a second salt bath 400 is so that the final strengthened glass-based article possesses a high CS at the surface of the glass-based article, such as a surface CS according to desired product specifications. That is, the first salt bath is utilized to impart a deep depth of compression with high CSk, while the second salt bath is utilized to impart high compressive stress at the surface of the glass-based article.

The ion exchange process shown in FIGS. 4A and 4B includes immersing a glass-based substrate 405 containing lithium cations (smaller cations) 430 in a salt bath 400, which contains fresh molten salt 401 containing larger alkali metal cations 420, where the larger alkali metal cations are larger than the lithium cations. The larger alkali metal cations 420 may comprise potassium, sodium, or combinations thereof, which have disassociated from KNO₃, NaNO₃ or combinations thereof present in the salt bath 400. Referring specifically to FIG. 4B, salt bath 400 is considered to be “poisoned,” when lithium cations 430 exchanged from the glass-based substrate are present in poisoned molten salt 402. Over time, the concentration of lithium cations 430 in the salt bath 400 increases as lithium cations 430 diffuse from the lithium-containing glass-based substrate 405 into the poisoned molten salt 402, and consequently, the poisoning level of the salt bath 400 increases.

In some embodiments, the lithium-containing ion-exchanged glass-based substrate 405 may be contacted with the second salt bath 400 for a second treatment time. In embodiments, the second treatment time may be from about 10 minutes to about 4 hours, such as from about 10 minutes to about 3 hours, from about 10 minutes to about 2 hours, from about 10 minutes to about 1 hour, from about 10 minutes to about 30 minutes, from about 30 minutes to about 4 hours, from about 30 minutes to about 3 hours, from about 30 minutes to about 2 hours, from about 30 minutes to about 1 hour, from about 1 hour to about 4 hours, from about 1 hour to about 3 hours, from about 1 hour to about 2 hours, from about 2 hours to about 4 hours, from about 2 hours to about 3 hours, or from about 3 hours to about 4 hours, and any and all sub-ranges formed from these endpoints.

In embodiments, a second salt bath with a composition different from the first salt bath may be used. In embodiments the second salt bath 400 may comprise an initial concentration of less than 1 wt. % LiNO₃. In embodiments, the initial concentration of LiNO₃ in the second salt bath is based on the composition of the lithium-containing ion-exchanged glass-based substrate 405 to provide an ion exchange that increases both CS and CSk. In embodiments, the second salt bath 400 may initially comprise from 0 wt. % LiNO₃ to about 1 wt. % LiNO₃ or from 0 wt. % to about 0.5 wt. % LiNO₃, and any and all sub-ranges formed from these endpoints.

In embodiments, the second salt bath 400 may comprise at least one of KNO₃ and NaNO₃. In other embodiments, the second salt bath 400 may comprise a combination of KNO₃ and NaNO₃. In embodiments, the concentrations of KNO₃ and NaNO₃ in the second salt bath may be balanced based on the composition of the lithium-containing ion-exchanged glass-based substrate 405 to provide an ion exchange that increases both CS and CSk. Depending on the desired properties of the finished product, in some embodiments, the second salt bath 400 may be operated with a lesser concentration of NaNO₃ and for a shorter treatment time as compared to the first salt bath 300, which results in a higher CS at the surface of the glass after contact with the second salt bath 400. Furthermore, because the second salt bath 400 may be operated at lesser NaNO₃ concentrations for a shorter time, the second salt bath 400 may be poisoned with lithium from the lithium-containing ion-exchanged glass-based substrate 405 at a much slower rate and reach a steady-state concentration of lithium at a much lower lithium level in the salt bath. In further embodiments, the second salt bath comprises a greater concentration of KNO₃ than NaNO₃ based on the total concentration of the second salt bath. In embodiments, the second salt bath 400 may comprise about 5 wt. % to about 100 wt. % KNO₃, such as from about 45 wt. % to about 50 wt. % KNO₃, or from about 75 wt. % to about 95 wt. % KNO₃, and any and all sub-ranges formed from these endpoints. In embodiments, the second salt bath 400 may comprise from 0 wt. % to about 95 wt. % NaNO₃, such as from 0 wt. % to about 50 wt. % NaNO₃, or from about 5 wt. % to about 25 wt. % NaNO₃, and any and all sub-ranges formed from these endpoints.

In some embodiments, the second salt bath 400 may be free or substantially free of phosphate salts, such as trisodium phosphate. In further embodiments, the second salt bath 400 may include from 0 wt. % to about 1 wt. % trisodium phosphate, such as from 0 wt. % to about 0.5 wt. % trisodium phosphate, or from 0 wt. % to about 0.1 wt. % trisodium phosphate, and any and all sub-ranges formed from these endpoints.

As stated previously, the ion exchange process is promoted by heating the second salt bath 400 during the exchange. However, if the temperature of the second salt bath 400 is too high, it may be difficult to adequately control the ion exchange process and may be difficult to obtain the desired CS. Accordingly, the second salt bath 400 may, in some embodiments, be heated to a temperature from about 350° C. to about 550° C., such as from about 350° C. to about 500° C., from about 350° C. to about 450° C., from about 350° C. to about 400° C., from about 450° C. to about 550° C., from about 450° C. to about 500° C., or from about 500° C. to about 550° C., and any and all sub-ranges formed from these endpoints.

In embodiments, contacting the lithium-containing substrate with both the first and second salt bath produces a strengthened glass-based article with desirable CS, CSk, and DOC properties. Furthermore, the disclosed methods also exhibit improved run-to-run dimensional stability because the lithium poising level of the first salt bath is maintained over time at or near steady-state concentrations. As stated previously, in ion exchange processes, salt bath life is limited by the lithium poisoning level, which is conventionally maintained below a threshold level of 0.5 wt. % LiNO₃. As described herein, by increasing the LiNO₃ concentration limit (poisoning level) in the first salt bath, the first salt bath operates at near steady-state lithium concentrations because there is balance between the lithium entering the salt bath from the glass-based substrates and lithium removed from the salt bath through drag out, which reduces article-to-article variations in the stress profile over time. Meanwhile, the second salt bath, if utilized, may continue to operate below a lesser threshold level (for example, 0.5 wt. %). In such conventional methods, a second salt bath of a double ion exchange process may operate under this lithium concentration threshold for longer periods of time, but the first salt bath may quickly reach and exceed this threshold after only a few ion exchange cycles for the reasons stated previously. Therefore, the disclosed methods extend bath life of the first salt bath, and both salt baths overall, when compared to conventional methods.

In embodiments, the extended bath life and improved run-to-run dimensional stability may be observed through consistent CS properties imparted to lithium-containing glass-based articles over the life of the salt baths. In embodiments where the first salt bath comprises at least about 2 wt. % LiNO₃, the CS imparted to the lithium-containing ion-exchanged glass-based article by the contacting steps decreases by less than 30 MPa after processing a cumulative amount of from about 3 square meters to about 13 square meters of lithium-containing glass-based substrates per kilogram of molten salt (m²/kg salt). In other embodiments, the CS imparted decreases by less than 30 MPa after processing a cumulative amount of lithium-containing glass-based substrates from about 3 m²/kg salt to about 10 m²/kg salt, or from about 3 m²/kg salt to about 5 m²/kg salt. In some embodiments, the CS imparted decreases by less than 30 MPa after processing a cumulative amount of lithium-containing glass-based substrates from about 5 m²/kg salt to about 13 m²/kg salt, or from about 5 m²/kg salt to about 10 m²/kg salt. In still other embodiments, the CS imparted decreases by less than 30 MPa processing a cumulative amount of lithium-containing glass-based substrates from about 10 m²/kg salt to about 13 m²/kg salt. For purposes of this metric, the cumulative amount of lithium-containing glass-based substrates is defined by the surface area of one side of a flat glass-based substrate and includes multiple runs of lithium-containing glass-based substrates in the salt bath, and the mass of the salt (in kg) is defined by the total weight of molten salt in the salt bath. In embodiments, the CS imparted to lithium-containing glass-based articles decreases by less than 60 MPa/m²/kg salt when the concentration of lithium nitrate in the first salt bath is at least 2 wt. %. In further embodiments, the CS imparted to lithium-containing substrates decreases by less than 40 MPa/m²/kg salt when the concentration of lithium nitrate in the first salt bath is at least 2.5 wt. %, decreases by less than 30 MPa/m²/kg salt when the concentration of lithium nitrate in the first salt bath is at least 3 wt. %, or decreases by less than 20 Ma/m²/kg salt when the concentration of lithium nitrate in the first salt bath is at least 3.5 wt. %.

In some embodiments, the method may further include adding at least one of fresh potassium nitrate or fresh sodium nitrate to either the first salt bath 300, the second salt bath 400, or both at an amount effective to reduce the concentration of lithium cations in the tank and restore balance between the lithium cations in the salt bath and lithium cations removed through drag out.

While the ion exchange methods are described herein in terms of first and second salt baths, it should be understood that other embodiments are contemplated. For example, in some embodiments, the method may further include contacting the lithium-containing glass-based substrate with one or more additional salt baths comprising at least one of potassium nitrate and sodium nitrate.

Additionally, embodiments of the disclosed process are contemplated that may include further processing steps. For example, in some embodiments, the method may further include additional or intermediate processing steps, such as rinsing the lithium-containing glass-based substrate before contacting the lithium-containing ion-exchanged glass-based substrate with the second salt bath 400.

Also, contemplated embodiments of the present disclosure are directed to a salt bath system for strengthening lithium-containing glass-based substrates that includes embodiments of the first salt bath and the second salt bath as described above.

The following examples illustrate one or more embodiments of the present disclosure as previously discussed above. The description of the embodiments is illustrative in nature and is in no way intended to be limiting it its application or use.

### Examples

The embodiments described herein will be further clarified by the following examples.

To observe and compare the effects of the disclosed ion exchange methods to known ion exchange methods, lithium-containing substrates, specifically, lithium-containing glass substrates, were tested for CS, depth of layer (DOL), CT, CSk, DOC, and Δm/m. Both computer modeling and experimental tests were performed on glass samples with a thickness of 0.55 mm and a composition as provided in Table 1.

TABLE 1
Composition of Example Glass 1.

| Example Glass 1 | Mol % |
|---|---|
| SiO₂ | 63.46 |
| Al₂O₃ | 15.71 |
| Li₂O | 6.37 |
| Na₂O | 10.69 |
| MgO | 0.06 |
| ZnO | 1.15 |
| P₂O₅ | 2.45 |
| SnO₂ | 0.04 |

For the modeled and experimental studies, the bath conditions are provided in Table 2.

TABLE 2
Bath Conditions.

| | Example 1 | | Example 2 | | Example 3 | |
|---|---|---|---|---|---|---|
| | Bath 1 | Bath 2 | Bath 1 | Bath 2 | Bath 1 | Bath 2 |
| | (E1-B1) | (E1-B2) | (E2-B1) | (E2-B2) | (E3-B1) | (E3-B2) |
| KNO₃ | 62 | 91 | 62 | 91 | 62 | 91 |
| (wt. %) | | | | | | |
| NaNO₃ | 38 | 9 | 35.8 | 9 | 33.5 | 9 |
| (wt. %) | | | | | | |
| LiNO₃ | 0 | 0 | 2.2 | 0 | 4.5 | 0 |
| (wt. %) | | | | | | |
| T (° C.) | 380 | 380 | 380 | 380 | 380 | 380 |
| t (min) | 90 | 26 | 90 | 26 | 90 | 26 |

The Examples differed by the salt composition in each of the first baths (Bath 1). In Example 1, Bath 1 (E1-B1), the initial concentration of LiNO₃ was 0 wt. %, the concentration of KNOB was 62 wt. %, and the concentration of NaNO₃ was 38 wt. %. In Example 2, Bath 1 (E2-B1), the initial concentration of LiNO₃ was 2.2 wt. %, the concentration of KNO₃ was 62 wt. %, and the concentration of NaNO₃ was 35.8 wt. %. In Example 3, Bath 1 (E3-B1), the initial concentration of LiNO₃ was 4.5 wt. %, the concentration of KNO₃ was 62 wt. %, and the concentration of NaNO₃ was 33.5 wt. %. In each of Example 1, Bath 2 (E1-B2); Example 2, Bath 2 (E2-B2); and Example 3, Bath 2 (E3-B2), the initial concentration of LiNO₃ was 0 wt. %, the concentration of KNO₃ was 91 wt. %, and the concentration of NaNO₃ was 9 wt. %.

As provided in Table 2, for each of Example 1 (comparative), Example 2, and Example 3, both Bath 1 (B1) and Bath 2 (B2) had a temperature of about 380° C. Also, for each of the Examples, the bath time was held constant at 90 minutes for each B1 and 26 minutes for each B2.

Modeling Results

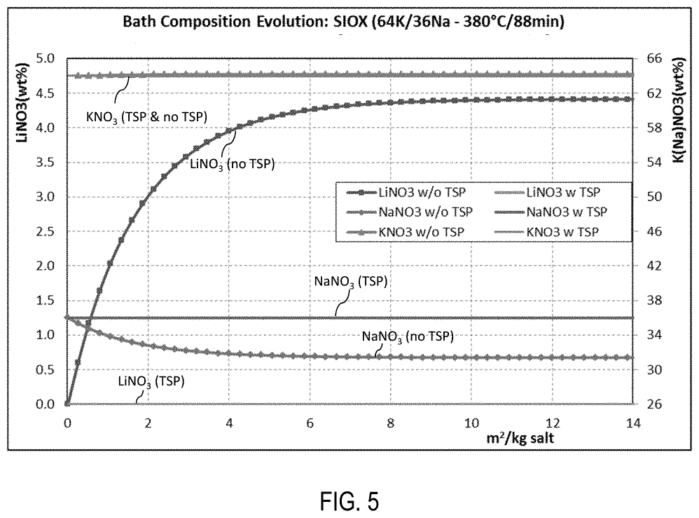

The evolution of the bath chemistry and CS for a glass sample were simulated using a computer model as a function of the cumulative square meter (m²) of glass processed per 1 kg salt. As stated previously, the conventional method analyzed here utilized a first salt bath without an initial concentration of LiNO₃ (Example 1). The composition of the glass used for this study is provided in Table 1, and the modeling results are provided in Table 4 and illustrated in FIGS. 5-9, and discussed in the following paragraphs.

TABLE 3
Stress Attributes-Modeling Results.

| | Example 1 | | Example 2 | | Example 3 | |
|---|---|---|---|---|---|---|
| | Bath 1 | Bath 2 | Bath 1 | Bath 2 | Bath 1 | Bath 2 |
| | (E1-B1) | (E1-B2) | (E2-B1) | (E2-B2) | (E3-B1) | (E3-B2) |
| Δm/m (%) | 0.5016 | 0.0667 | 0.3599 | 0.0972 | 0.2478 | 0.1331 |
| CSk (MPa) | 135.4 | 111.8 | 91.6 | 87.7 | 64.2 | 68.7 |
| CS (MPa) | 583.2 | 828.7 | 476.9 | 831.7 | 409.5 | 828.7 |
| CT (MPa) | −61.8 | −62.2 | −41.6 | −50.2 | −29.0 | −41.8 |
| DOL (μm) | 8.2 | 10.0 | 8.2 | 9.6 | 8.2 | 9.3 |
| DOC (μm) | 103.0 | 102.0 | 101.0 | 100.0 | 99.0 | 98.0 |

As provided in Table 3 (and confirmed by the experimental results presented subsequently in Table 4), the results show that the CS of the glass after the second salt bath was consistent for each of Examples 1 through 3. In Example 1, where the first salt bath was modeled with an initial LiNO₃ concentration of 0 wt. %, the CS after the second salt bath was 828.7 MPa. Example 2, modeled with an initial LiNO₃ concentration of 2.2 wt. % in the first salt bath, actually showed a higher CS of 831.7 MPa after the second salt bath. Example 3, modeled with an initial LiNO₃ concentration of 4.5 wt. % in the first salt bath, also had a CS of 828.7 MPa after the second salt bath.

Also, the modeling results provided in Table 3 show a comparable DOC for each of Examples 1 through 3. After the second salt bath, the DOC was 102.0 μm, 100.0 μm, and 98.0 μm for Examples 1-3, respectively. Therefore, these modeling results show that the final properties of the strengthened glass are comparable for both the comparative example (Example 1) and the examples of embodiments of the disclosed method (Example 2 and Example 3). Moreover, this model supports that the quality of the strengthened glass may be maintained for double ion exchange methods that utilize a first salt bath that includes LiNO₃ (a “pre-poisoned” salt bath).

Additionally, FIGS. 5-9 illustrate that the disclosed methods allow for an extended bath life for the first salt bath, without compromising the quality of the strengthened glass.

FIG. 5 graphically depicts modeling results of the bath chemistry evolution for a single ion exchange salt bath as a function of the cumulative square meter (m²) of glass processed per 1 kg salt. The square meter (m²) of glass is defined by one side of the surface area of a flat glass. As shown in FIG. 5, at about 10 m²/kg, the concentration of LiNO₃ increases from 0 wt. % to 4.4 wt. % and the concentration of NaNO₃ decreases from 36 wt. % to 32 wt. %. The observed salt concentration changes (change rate) become less rapid as more square meters of glass is processed per 1 kg of salt. Consequently, as the LiNO₃ concentration change rate decreases, the salt bath appears to reach a steady state at about 4.5 wt. % LiNO₃ concentration. As a result, an equilibrium is reached between the lithium ions introduced into the salt bath through the ion exchange process and the lithium removed from the salt bath in the form of salt stuck to the glass surface (drag out). FIG. 5 also shows that as the lithium in the salt bath is converted from active to non-reactive form by adding trisodium phosphate (TSP) salt, the active lithium nitrate concentration can be reduced to zero, and both potassium nitrate concentration and sodium nitrate concentration can be restored to the original values.

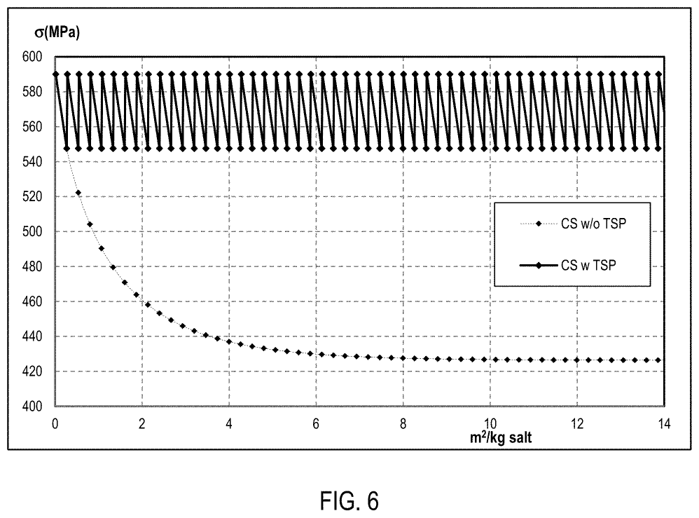

FIG. 6 graphically depicts modeling results of the change in CS over time for a single ion exchange salt bath with and without TSP. As shown in FIG. 6, at about 10 m²/kg, the concentration of LiNO₃ increases from 0 wt. % to 4.4 wt. %, and the CS drops from about 590 MPa to about 427 MPa. Comparatively, in a bath with TSP, as the lithium in the salt bath is converted from active to non-reactive form by adding TSP salt, the lithium concentration may be controlled at a lower level, while maintaining a CS values between about 545 MPa and 590 MPa. However, as stated above, the insoluble phosphate salts in the TSP process will eventually need to be removed, and the strengthened glass substrates will likely require additional cleaning to remove precipitate from the glass.

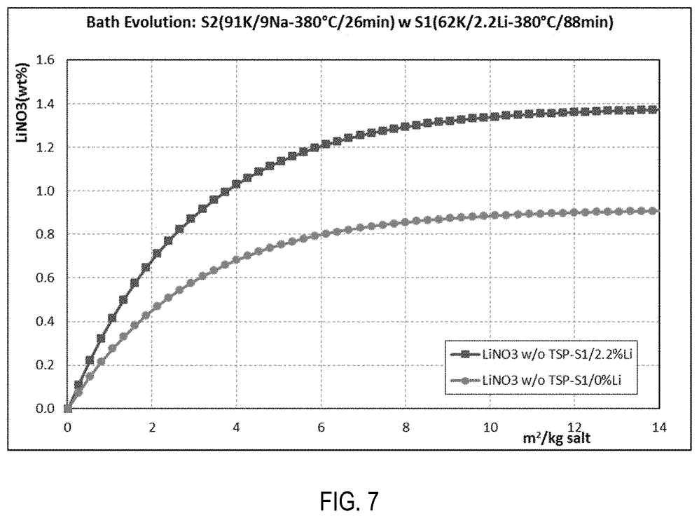

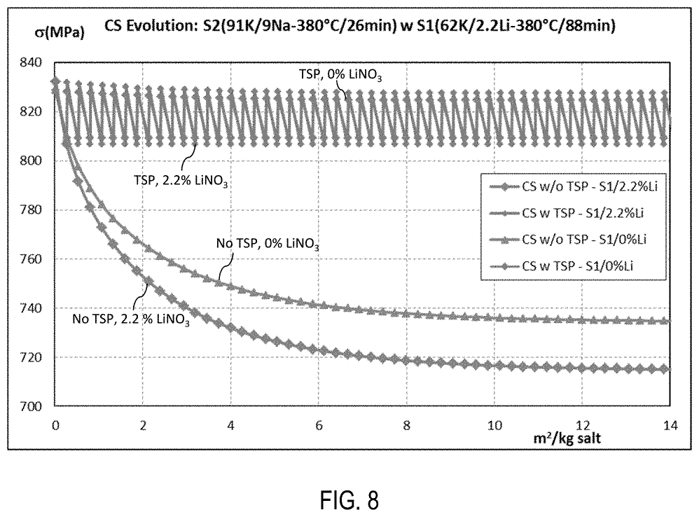

FIGS. 7 and 8 graphically depict modeling results of the bath chemistry evolution for a double ion exchange salt bath system. FIG. 7 depicts the modeling results as a function of the cumulative square meter (m²) of glass processed per 1 kg salt. FIG. 8 graphically depicts the modeling results of the change in CS over time for a double ion exchange salt bath system. The results of this model show that for a first salt bath with a LiNO₃ concentration of 0 wt. %, the LiNO₃ concentration reaches a steady-state value of about 0.9 wt. % beyond 9 m²/kg salt. For a first salt bath with a LiNO₃ concentration of 2.2 wt. %, the LiNO₃ concentration reaches a steady-state value of approximately 1.4 wt. % beyond 9 m²/kg salt, as illustrated in FIG. 7. Additionally, for a first salt bath with an initial LiNO₃ concentration of 0 wt. %, CS reaches a steady-state value of about 735 MPa beyond 9 m²/kg. For a first salt bath with an initial LiNO₃ concentration of 2.2 wt. %, CS reaches a steady-state value of about 717 MPa beyond 9 m²/kg, as illustrated in FIG. 8. With TSP addition, CS in both cases can be restored to about 825 MPa. The comparison observed through FIGS. 7 and 8 indicates that poisoning the first salt bath with a LiNO₃ concentration of 2.2 wt. % has limited impact on CS.

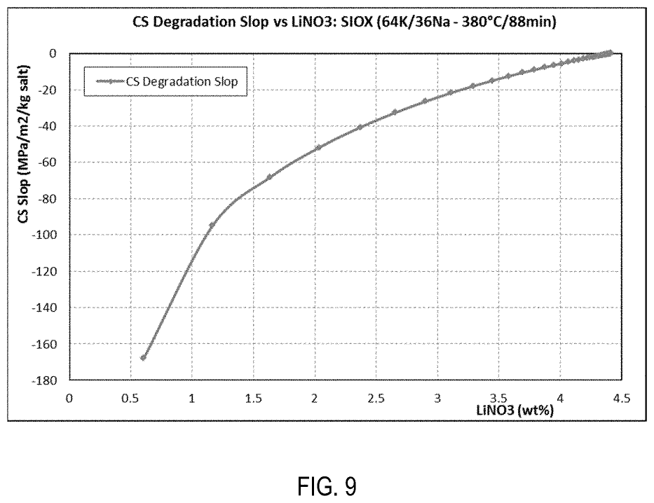

FIG. 9 graphically depicts the effect of lithium nitrate concentration level in a first salt bath on CS degradation. The “degradation slope” is a measurement of the change in CS for the cumulative square meters (m²) of lithium-containing substrate processed per 1 kg salt. In other words, the degradation slope shows how, over time, the CS imparted to the lithium-containing substrate decreases, or degrades, as more area of substrate material is processed. A lower degradation slope means that there is less difference in CS imparted to the strengthened (processed) substrates over time. In other words, the CS imparted to the strengthened substrates is more consistent as the degradation slope approaches zero. Here, the results of this model show that raising the concentration of LiNO₃ in the first salt bath from 0.5 wt. % to 3 wt. % reduces the degradation slope from about −180 MPa/m²/kg salt to about −25 MPa/m²/kg salt. Therefore, the results show that as the concentration of LiNO₃ (poisoning level) of the first salt bath increases, the strengthened lithium-containing glass articles exhibit more consistent CS from run to run, evidenced by the degradation slope approaching zero.

Experimental Results

An experimental study was conducted on 50 mm by 50 mm sized substrate samples of the glass composition provided in Table 1, which were chemically strengthened in the two-bath systems of Example 1, Example 2, and Example 3 under the conditions provided in Table 2. The experimental study was conducted to observe the stress attributes of the strengthened substrates including percentage weight gain (Δm/m), CSk, CS, CT, depth of layer (DOL). Specifically, CSk, CS, depth of layer (DOL) measurements were obtained by a surface stress meter (FSM), which is a commercially-available instrument, such as the FSM-6000, manufactured by Orihara Industrial Co., Ltd. (Japan). The surface stress measurements of the surface stress meter rely upon the accurate measurement of the stress optical coefficient (SOC), which is related to the birefringence of the substrate. SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. The maximum CT value was measured using a scattered light polariscope (SCALP) technique known in the art. Weight gain (Δm/m) is the mass gain (or loss) of the substrate after ion exchange, which was obtained by measuring the difference in the example's mass before and after the ion exchange process.

A drop test experiment was also conducted on strengthened substrate samples of the glass composition provided in Table 1. To perform the drop test experiment, 130.2 mm by 65.2 mm by 0.55 mm sized glass article samples, which were chemically strengthened in the two-bath systems of Example 1, Example 2, and Example 3 under the conditions provided in Table 2, were assembled to a metal puck. The metal puck used for each of the samples was held constant for each drop test experiment. Then, the metal puck was dropped with the substrate side facing toward the ground from heights between 20 cm and 220 cm in 10 cm increments onto fresh 180 grit sandpaper. For each drop that resulted in breakage (failure) of the substrate sample, the drop height was recorded.

To prepare the salt bath systems, salt baths containing mixtures of NaNO₃ and KNO₃ or NaNO₃, KNO₃, and LiNO₃ according to the conditions provided in Table 2 were melted at 380° C. for 12 hours. Each salt bath was then heated to the temperature provided in Table 2. Then, the glass substrates were strengthened (ion-exchanged) in these baths by placing the glass substrate in the bath for the time provided in Table 2.

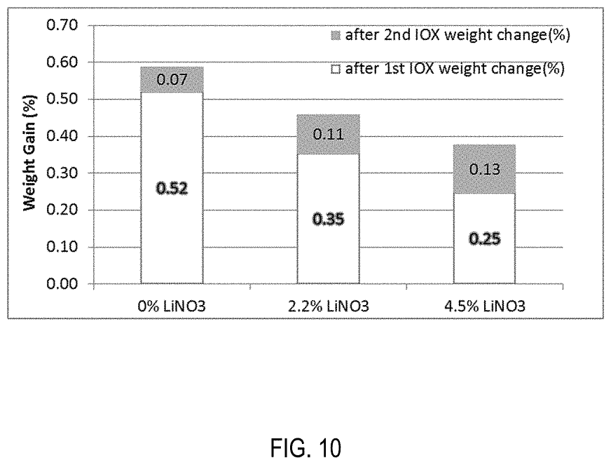

The results of these tests are provided in Table 4, illustrated in FIGS. 10-14, and discussed in the following paragraphs.

TABLE 4
Experimental Results.

| | Example 1 | | Example 2 | | Example 3 | |
|---|---|---|---|---|---|---|
| | Bath 1 | Bath 2 | Bath 1 | Bath 1 | Bath 2 | Bath 1 |
| | (E1-B1) | (E1-B2) | (E2-B1) | (E1-B1) | (E1-B2) | (E2-B1) |
| Δm/m (%) | 0.5219 | 0.0685 | 0.3521 | 0.1069 | 0.2453 | 0.1303 |
| CSk (MPa) | 145.2 | 101.0 | 75.8 | 88.9 | 52.9 | 83.6 |
| CS (MPa) | 584.0 | 838.6 | 460.0 | 819.6 | 417.6 | 821.6 |
| CT (MPa) | 62.1 | 62.3 | 41.3 | 49.8 | 28.4 | 41.8 |
| DOL (μm) | 8.3 | 8.7 | 8.0 | 8.4 | 7.8 | 8.6 |

As provided in Table 4, the results show that the strengthened glass had consistent CS after the second salt bath for each of Examples 1 through 3. In Example 1, where the first salt bath was prepared with an initial LiNO₃ concentration of 0 wt. %, the CS after the second salt bath was 838.6 MPa. Example 2, prepared with an initial LiNO₃ concentration of 2.2 wt. % in the first salt bath, had a CS of 819.7 MPa after the second salt bath. Additionally, Example 3, prepared with an initial LiNO₃ concentration of 4.5 wt. % in the first salt bath, had CS of 821.6 MPa after the second salt bath.

Also, the experimental results provided in Table 4 show a comparable DOL for each of Examples 1 through 3. After the second salt bath, the DOL was 8.7 μm, 8.4 μm, and 8.6 μm for Examples 1-3, respectively. These experimental results show that the final properties of the strengthened glass are comparable for both the comparative example (Example 1) and the examples of embodiments of the disclosed method (Example 2 and Example 3). Moreover, these experimental results support that the quality of the strengthened glass may be maintained for double ion exchange methods that utilize a first salt bath that includes LiNO₃ (a “pre-poisoned” salt bath). Furthermore, the agreement between the modeled and experimental results of Table 3 and Table 4, respectively, verify the model's capacity as a prediction tool. Therefore, the disclosed process not only produces strengthened glass with properties of an expected quality when compared to conventional processes, but the disclosed process also maintains this expected quality over a longer period of time, which is further described subsequently in this disclosure.

FIG. 10 graphically depicts a comparison of the percentage weight gain after the first ion exchange and second ion exchange for salt baths with 0% LiNO₃ in the first salt bath, 2.2% LiNO₃ in the first salt bath, and 4.5% LiNO₃ in the first salt bath. The results show that the percent weight gain was less for each of Example 2 (0.35% after the first salt bath and 0.11% after the second salt bath) and Example 3 (0.25% after the first salt bath and 0.13% after the second salt bath) when compared to Example 1 (0.52% after the first salt bath and 0.07% after the second salt bath). From these results, it was observed that as the poisoning level of the first salt bath increased, the weight gain after the first salt bath decreased, and the weight gain after the second salt bath increased. As a result, the total weight gain after both baths decreased slower while increasing the first salt bath's poisoning level, suggesting that the impact of poisoning level of the first salt bath on the ion exchange efficiency becomes less significant after two-step ion exchange.

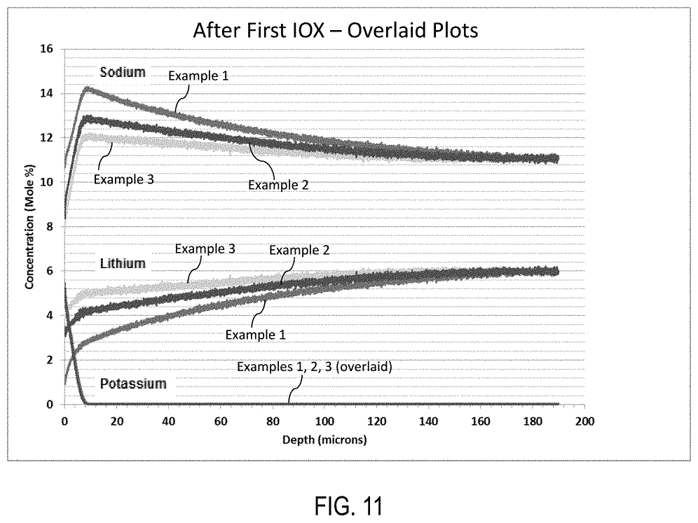

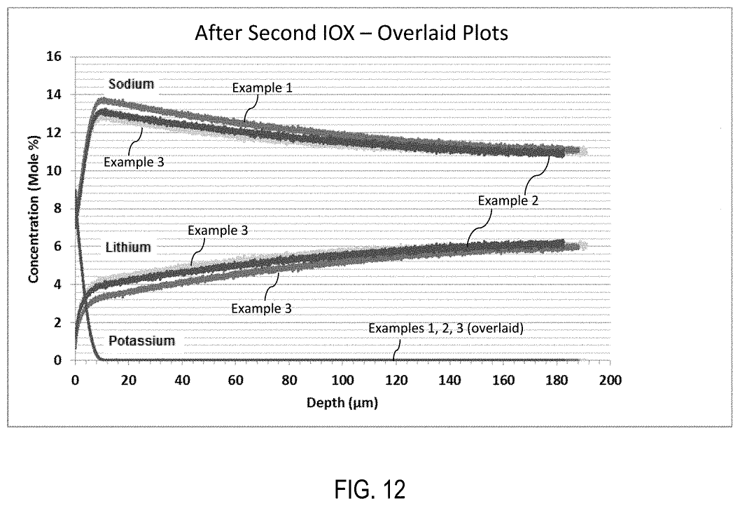

FIG. 11 graphically depicts the concentration profiles of lithium, sodium, and potassium (presented using their corresponding oxides mole concentration) after the first ion exchange for salt baths with 0% LiNO₃ in the first salt bath (Example 1), 2.2% LiNO₃ in the first salt bath (Example 2), and 4.5% LiNO₃ in the first salt bath (Example 3). After the first salt bath, the concentration profiles of lithium, sodium, and potassium (presented using their corresponding oxides mole concentration) show that the DOC differed for each of Examples 1, 2, and 3 as a result of their differences in conditions of the first salt bath. It was observed that although the potassium profiles were nearly identical for each example, the sodium and lithium profiles varied for the first salt baths with differing poisoning levels (0 wt. %, 2.2 wt. %, and 4.5 wt. % LiNO₃). However, FIG. 12 graphically depicts the concentration profiles of lithium, sodium, and potassium (presented using their corresponding oxide mole concentrations) after the second ion exchange for salt baths with 0% LiNO₃ in the first salt bath (Example 1), 2.2% LiNO₃ in the first salt bath (Example 2), and 4.5% LiNO₃ in the first salt bath (Example 3). After the second salt bath, the glass substrate samples for Examples 1, 2, and 3 showed similar profiles despite the differences in the first salt bath conditions. This observation is consistent with the weight gain observations, suggesting that the impact of poisoning level of the first salt bath on the ion exchange efficiency becomes less significant after two-step ion exchange.

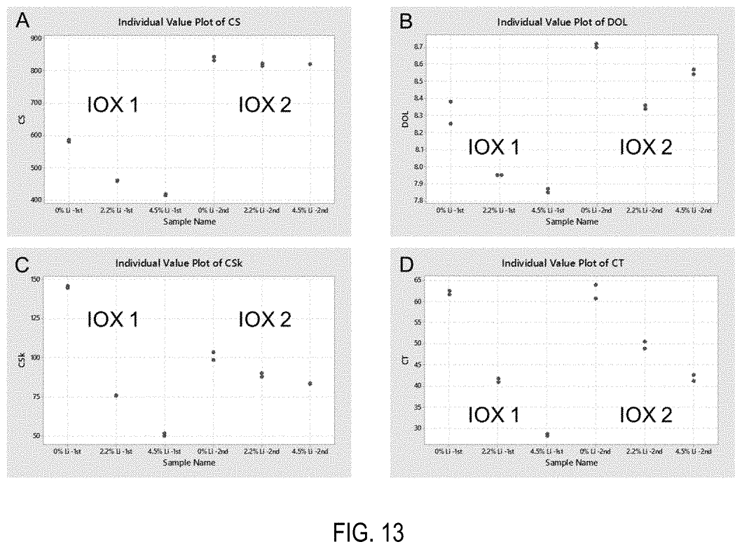

FIG. 13 graphically depicts the effect of lithium nitrate concentration level in the first salt bath on CS, DOL, CSk, and CT. These results show that varying the lithium nitrate concentration level in the first salt bath influenced CS, DOL, CSk, and CT. Higher lithium concentration lowered CS, DOL, CT, CSk dramatically. However, once the glass substrate was treated in the second salt bath (having no initial concentration over LiNO₃) the difference of CS, DOL, CSk, and CT between Example 1 and Examples 2 and 3 reduced significantly.

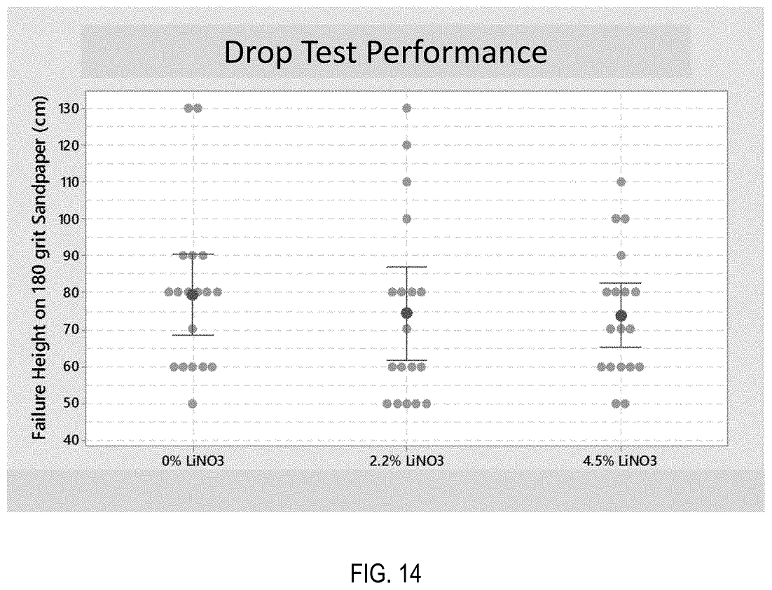

FIG. 14 graphically depicts the effect of lithium nitrate concentration level in the first salt bath on drop performance on 180 grit sandpaper. As shown in FIG. 14, the average failure height was between 70 cm and 80 cm for each of the three samples. The results therefore showed that drop performance was not significantly impacted by changing the LiNO₃ concentration level in the first salt bath.

Therefore, as discussed above, the results provided in Table 3 and Table 4 show the CS, CT, DOL and weight gain of the strengthened glass are comparable for each of Examples 1 through 3. These results show that when comparing conventional methods, which do not utilize a pre-poisoned salt bath as in Example 1, to the disclosed methods which utilize a first salt bath containing at least 2 wt. % lithium nitrate as in Examples 2 and 3, the resultant strengthened glasses have comparable quality.

However, as demonstrated in FIGS. 5-14, the disclosed processes can produce strengthened glasses having such properties for longer periods of time—without producing insoluble phosphate precipitates or requiring that the salt bath be changed. As discussed above, operating a salt bath at a higher poisoning level causes the LiNO₃ concentration change rate to reduce over time, as illustrated in FIG. 5. This is because the first salt bath appears to reach a steady state at a certain LiNO₃ concentration (poisoning level), and at that level, an equilibrium is reached between the lithium ions introduced into the salt bath through the ion exchange process and the lithium removed from the salt bath in the form of salt stuck to the glass surface (drag out). FIGS. 6-9 further show the effect of lithium nitrate concentration level in a first salt bath on CS degradation. From this data, it appears that increasing the poisoning level of LiNO₃ in the first salt bath above 0.5 wt. % reduces the degradation slope. For these reasons, the data shows that the disclosed methods provide glass substrates with the desired strength conditions for an extended period of time with less degradation compared to conventional methods (which operate at lower poisoning levels and/or with TSP).

It should be apparent to those skilled in the art that various modifications and variations can be made to the described embodiments without departing from the spirit and scope of the claimed subject matter. Thus, it is intended that the specification cover the modifications and variations of the various described embodiments provided such modification and variations come within the scope of the appended claims and their equivalents.

The present disclosure includes one or more non-limiting aspects. A first aspect may include a method. The method comprises: contacting at least a portion of a glass-based substrate with a first salt bath comprising greater than or equal to 2 wt. % lithium nitrate and at least one of potassium nitrate and sodium nitrate to form an ion-exchanged glass-based substrate; and contacting at least a portion of the ion-exchanged glass-based substrate with a second salt bath comprising at least one of potassium nitrate and sodium nitrate to form a glass-based article. The glass-based substrate comprises lithium.

A second aspect includes the first aspect, wherein the first salt bath comprises a greater concentration of sodium nitrate than the second salt bath based on the total concentration of each salt bath.

A third aspect includes any of the preceding aspects, wherein the second salt bath comprises from greater than or equal to 0 wt. % to less than or equal to 1 wt. % lithium nitrate.

A fourth aspect includes any of the preceding aspects, wherein the first salt bath has a temperature from greater than or equal to 350° C. to less than or equal to 520° C.

A fifth aspect includes any of the preceding aspects, wherein the second salt bath has a temperature from greater than or equal to 350° C. to less than or equal to 520° C.

A sixth aspect includes any of the preceding aspects, further comprising contacting at least a portion of the glass-based substrate with the first salt bath for a first treatment time from greater than or equal to 20 minutes to less than or equal to 20 hours.

A seventh aspect includes any of the preceding aspects, further comprising contacting at least a portion of the ion-exchanged glass-based substrate with the second salt bath for a second treatment time from greater than or equal to 10 minutes to less than or equal to 4 hours.

An eighth aspect includes any of the preceding aspects, further comprising adding at least one of potassium nitrate or sodium nitrate to the first salt bath, the second salt bath, or both.

A ninth aspect includes any of the preceding aspects, further comprising contacting the glass-based substrate with one or more additional salt baths comprising at least one of potassium nitrate and sodium nitrate.

A tenth aspect includes any of the preceding aspects, further comprising rinsing the ion-exchanged glass-based substrate before contacting the ion-exchanged glass-based substrate with the second salt bath.

An eleventh aspect includes any of the preceding aspects, wherein the first salt bath is substantially free from trisodium phosphate.

A twelfth aspect includes any of the preceding aspects, wherein the first salt bath comprises from greater than or equal to 2 wt. % to less than or equal to 6 wt. % lithium nitrate.

A thirteenth aspect includes any of the preceding aspects, wherein the first salt bath comprises from greater than or equal to 2 wt. % to less than or equal to 5 wt. % lithium nitrate.

A fourteenth aspect may include a salt bath system. The salt bath system comprises: a first salt bath comprising at least one of potassium nitrate and sodium nitrate and greater than or equal to 2 wt. % lithium nitrate, wherein the first salt bath is maintained at a temperature from greater than or equal to 350° C. to less than or equal to 520° C.; and a second salt bath comprising at least one of potassium nitrate and sodium nitrate and less than or equal to 1 wt. % lithium nitrate, wherein the second salt bath is maintained at a temperature from greater than or equal to 350° C. to less than or equal to 520° C.

A fifteenth aspect may include the fourteenth aspect, wherein the first salt bath comprises from greater than or equal to 2 wt. % to less than or equal to 6 wt. % lithium nitrate.

A sixteenth aspect may include any of aspects fourteen through fifteen, wherein the first salt bath comprises a greater concentration of sodium nitrate than the second salt bath based on the total concentration of each salt bath.

A seventeenth aspect may include any of aspects fourteen through sixteen, wherein the first salt bath comprises from greater than or equal to 5 wt. % to less than or equal to 95 wt. % of sodium nitrate.

A eighteenth aspect may include any of aspects fourteen through seventeen, wherein the first salt bath comprises from greater than or equal to 5 wt. % to less than or equal to 95 wt. % potassium nitrate.

A nineteenth aspect may include any of aspects fourteen through eighteen, wherein the second salt bath comprises a greater concentration of potassium nitrate than sodium nitrate based on the total concentration of the second salt bath.

A twentieth aspect may include any of aspects fourteen through nineteen, wherein the second salt bath comprises from greater than or equal to 5 wt. % to less than or equal to 100 wt. % potassium nitrate.

A twenty-first aspect may include any of aspects fourteen through twenty, wherein the second salt bath comprises from greater than or equal to 0 wt. % to less than or equal to 95 wt. % sodium nitrate.

A twenty-second aspect may include any of aspects fourteen through twenty-one, wherein the first salt bath is substantially free from trisodium phosphate.

A twenty-third aspect may include a method. The method comprises: contacting a first batch of glass-based substrates with a first salt bath comprising greater than 2 wt. % lithium nitrate and at least one of potassium nitrate and sodium nitrate to form a first batch of ion-exchanged glass-based substrates, wherein the glass-based substrates comprise lithium, and lithium cations diffuse from the glass-based substrates into the first salt bath; contacting the first batch of ion-exchanged glass-based substrates with a second salt bath comprising at least one of potassium nitrate and sodium nitrate to form a first batch of glass-based articles, wherein lithium cations diffuse from the ion-exchanged glass-based substrates into the second salt bath. A surface compressive stress imparted to the glass-based articles by the contacting steps decreases by less than 30 MPa after contacting from greater than or equal to 3 m² of glass-based substrates per kilogram of molten salt (m²/kg salt) to 13 m²/kg salt in the first salt bath.

What is claimed is:

1. A method, comprising:
contacting at least a portion of a glass-based substrate with a first salt bath comprising greater than or equal to 2 wt. % lithium nitrate and at least one of potassium nitrate and sodium nitrate to form an ion-exchanged glass-based substrate; and
contacting at least a portion of the ion-exchanged glass-based substrate with a second salt bath comprising at least one of potassium nitrate and sodium nitrate to form a glass-based article,
wherein the glass-based substrate comprises lithium.

2. The method of claim 1, wherein the first salt bath comprises a greater concentration of sodium nitrate than the second salt bath based on the total concentration of each salt bath.

3. The method of claim 1, wherein the second salt bath comprises from greater than or equal to 0 wt. % to less than or equal to 1 wt. % lithium nitrate.

4. The method of claim 1, wherein the first salt bath has a temperature from greater than or equal to 350° C. to less than or equal to 520° C.

5. The method of claim 1, wherein the second salt bath has a temperature from greater than or equal to 350° C. to less than or equal to 520° C.

6. The method of claim 1, further comprising contacting at least a portion of the glass-based substrate with the first salt bath for a first treatment time from greater than or equal to 20 minutes to less than or equal to 20 hours.

7. The method of claim 1, further comprising contacting at least a portion of the ion-exchanged glass-based substrates with the second salt bath for a second treatment time from greater than or equal to 10 minutes to less than or equal to 4 hours.

8. The method of claim 1, further comprising adding at least one of potassium nitrate or sodium nitrate to the first salt bath, the second salt bath, or both.

9. The method of claim 1, further comprising contacting the glass-based substrate one or more additional salt baths comprising at least one of potassium nitrate and sodium nitrate.

10. The method of claim 1, further comprising rinsing the ion-exchanged glass-based substrate before contacting the ion-exchanged glass-based substrate with the second salt bath.

11. The method of claim 1, wherein the first salt bath is substantially free from trisodium phosphate.

12. The method of claim 1, wherein the first salt bath comprises from greater than or equal to 2 wt. % to less than or equal to 6 wt. % lithium nitrate.

13. The method of claim 1, wherein the first salt bath comprises from greater than or equal to 2 wt. % to less than or equal to 5 wt. % lithium nitrate.

14. A salt bath system, comprising:
a first salt bath comprising at least one of potassium nitrate and sodium nitrate and greater than or equal to 2 wt. % lithium nitrate, wherein the first salt bath is maintained at a temperature from greater than or equal to 350° C. to less than or equal to 520° C.; and
a second salt bath comprising at least one of potassium nitrate and sodium nitrate and less than or equal to 1 wt. % lithium nitrate, wherein the second salt bath is maintained at a temperature from greater than or equal to 350° C. to less than or equal to 520° C.

15. The salt bath system of claim 14, wherein the first salt bath comprises from greater than or equal to 2 wt. % to less than or equal to 6 wt. % lithium nitrate.

16. The salt bath system of claim 14, wherein the first salt bath comprises a greater concentration of sodium nitrate than the second salt bath based on the total concentration of each salt bath.

17. The salt bath system of claim 14, wherein the first salt bath comprises from greater than or equal to 5 wt. % to less than or equal to 95 wt. % of sodium nitrate.

18. The salt bath system of claim 14, wherein the first salt bath comprises from greater than or equal to 5 wt. % to less than or equal to 95 wt. % potassium nitrate.

19. The salt bath system of claim 14, wherein the second salt bath comprises a greater concentration of potassium nitrate than sodium nitrate based on the total concentration of the second salt bath.

20. The salt bath system of claim 14, wherein the second salt bath comprises from greater than or equal to 5 wt. % to less than or equal to 100 wt. % potassium nitrate.

21. The salt bath system of claim 14, wherein the second salt bath comprises from greater than or equal to 0 wt. % to less than or equal to 95 wt. % sodium nitrate.

22. The method of claim 14, wherein the first salt bath is substantially free from trisodium phosphate.

23. A method, comprising:
contacting a first batch of glass-based substrates with a first salt bath comprising greater than 2 wt. % lithium nitrate and at least one of potassium nitrate and sodium nitrate to form a first batch of ion-exchanged glass-based substrates, wherein the glass-based substrates comprises lithium, and lithium cations diffuse from the glass-based substrates into the first salt bath;
contacting the first batch of the ion-exchanged glass-based substrates with a second salt bath comprising at least one of potassium nitrate and sodium nitrate to form glass-based articles, wherein lithium cations diffuse from the ion-exchanged glass-based substrates into the second salt bath; and
wherein a surface compressive stress imparted to the glass-based articles by the contacting steps decreases by less than 30 MPa after contacting from greater than or equal to 3 m² of glass-based substrates per kilogram of molten salt (m²/kg salt) to less than or equal to 13 m²/kg salt in the first salt bath.
